(19) United States
(12) Patent Application Publication
(10) Pub. No.: US 2026/0267141 A1
(43) Pub. Date: Sep. 10, 2026

(54) LAMINATED PANE WITH SEVERAL REFLECTIVE REGIONS AND WEDGE-SHAPED INTERMEDIATE LAYER

(71) Applicant: SAINT-GOBAIN GLASS FRANCE, COURBEVOIE (FR)

(72) Inventors: Andreas GOMER, HERZOGENRATH (DE); Sebastian ARENDT, HERZOGENRATH (DE); Michele CAPPUCCILLI, HERZOGENRATH (DE)

(21) Appl. No.: 18/869,391

(22) PCT Filed: Jul. 25, 2023
(86) PCT No.: PCT/EP2023/070549

§ 371 Date: Nov. 26, 2024

(30) Foreign Application Priority Data
Aug. 3, 2022 (EP) 22188420.8

(51) Int. Cl. G02B 27/01

(52) U.S. Cl. CPC G02B 27/0101

(57) ABSTRACT

A laminated pane for a projection arrangement having an HUD region, includes an outer pane, a wedge-shaped thermoplastic intermediate layer, and an inner pane, a masking layer, and a reflective layer, wherein the reflective layer is arranged between the outer pane and the inner pane and outside an HUD region of the laminated pane, wherein the reflective layer is arranged closer than the masking layer to the inner pane and is arranged completely within the masking layer in a plan view of the laminated pane as seen from the inner pane, wherein the thermoplastic intermediate layer is wedge-shaped at least in the HUD region.

The invention relates to a laminated pane for a projection arrangement, to a method for the production thereof, to the use thereof, and to a projection arrangement with the laminated pane.

Modern automobiles are increasingly equipped with so-called head-up displays (HUDs). With a projector, typically in the area of the dashboard, images are projected onto the HUD region of the windshield, reflected there and perceived by the driver as a virtual image behind the windshield (as seen by the driver). Thus, important information can be projected into the field of vision of the driver, for example, the current travel speed, navigation messages or warnings that the driver can perceive without having to turn his gaze away from the road. Head-up displays can thus contribute substantially to increasing traffic safety.

The problem with the head-up displays described above is that the virtual image is reflected on both surfaces of the windshield. As a result, the driver perceives not only the desired primary image that is produced by the reflection on the interior-side surface of the windshield (primary reflection). The driver also perceives a slightly offset secondary image that is generally less intense and is produced by the reflection on the outer surface of the windshield (secondary reflection). The latter is commonly also referred to as a ghost image. This problem is commonly solved by arranging the reflective surfaces at a specifically selected angle to one another so that the primary image and the ghost image are superimposed, as a result of which the ghost image no longer has a disruptive effect.

Windshields usually consist of two glass panes which are laminated to one another via a thermoplastic film. If the surfaces of the glass panes are to be arranged at an angle as described, it is customary to use a thermoplastic film with a non-constant thickness. This is also referred to as a wedge-shaped film or wedge film. The angle between the two surfaces of the film is referred to as the wedge angle. The wedge angle can be constant over the entire film (linear thickness change) or change depending on the position (non-linear thickness change). Laminated glasses with wedge films are known, for example, from WO2009/071135A1, EP1800855B1, WO2021213884A1 or EP1880243A2.

Apart from the transparent see-through region, windshields usually have an opaque masking region with an opaque layer, through which it is not possible to see. The masking region is typically arranged in a peripheral edge region of the windshield and borders the see-through region. The opaque masking region serves primarily to protect the adhesive used for bonding the windshield to the vehicle body from UV radiation. The masking region is typically formed by a black covering print on the surface of the outer pane facing the intermediate layer.

It is possible to generate a virtual image even in the masking region. Thus, the masking region is also irradiated by a projector and the light is reflected there, thereby generating a display for the driver. Thus, for example, information which has been previously displayed in the region of the dashboard, such as the time, travel speed, engine speed, or information of a navigation system, or also the image of a rearward-directed camera, which replaces the conventional exterior mirrors or rearview mirrors, can be displayed directly on the windshield in a practical and aesthetically appealing manner-for example, in the section of the masking region which borders the lower edge of the windshield. A projection arrangement of this type is known, for example, from DE102009020824A1 and WO2022073894A1.Homogeneous reflection of light in the masking region presents other demands on the structure of a laminated pane than those in the case of an HUD reflection.

The object of the present invention is therefore to provide an improved projection arrangement, using a laminated pane, which can be used both as a component of a classical HUD projection arrangement and a projection arrangement with a masking region, wherein a homogeneous reflection is achieved for both types of projection arrangements.

The object of the present invention is achieved according to the invention by a laminated pane according to claim 1. Preferred embodiments result from the dependent claims.

The invention relates to a laminated pane for a projection arrangement with an HUD region (head-up display region). The laminated pane comprises an outer pane, an inner pane and a thermoplastic intermediate layer, which is arranged between the inner pane and the outer pane and is wedge-shaped at least in regions. The thermoplastic intermediate layer preferably extends over the entire area of the laminated pane, i.e., is arranged flat between the outer pane and the inner pane. The thermoplastic intermediate layer is wedge-shaped at least in an HUD region of the laminated pane. The thermoplastic intermediate layer is therefore wedge-shaped at least in the region in which the thermoplastic intermediate layer and the HUD region overlap one another when looking through the laminated pane.

In addition, the laminated pane according to the invention comprises a masking layer and a reflective layer. The reflective layer is arranged between the outer pane and the inner pane and outside of the HUD region of the laminated pane. “Outside of the HUD region” means that the reflective layer does not overlap with the HUD region when viewed through the laminated pane. The reflective layer is arranged closer than the masking layer to the inner pane and is arranged completely within the masking layer in a plan view of the laminated pane as seen from the inner pane. In other words, the reflective layer is completely covered by the masking layer when viewed through the laminated pane, seen from the outer pane. When viewed through the laminated pane, “seen from the outer pane” means looking in the direction from the outer pane to the inner pane. When viewed through the laminated pane, “seen from the inner pane” means looking in the direction from the inner pane to the outer pane.

The fact that the reflective layer is arranged closer to the inner pane than the masking layer is means, within the meaning of the invention, that, when viewed through the laminated pane, the masking layer is arranged behind the reflective layer as seen from the inner pane. The reflective layer is therefore arranged on the inside of the pane in front of the masking layer.

The fact that the reflective layer is completely covered by the masking layer when viewed through the laminated pane as seen from the outer pane means within the meaning of the invention that, conversely, the reflective layer is arranged completely in front of the masking layer when viewed through the laminated pane looking in the direction from the inner pane to the outer pane. The masking layer can thus be arranged congruently with the reflective layer or extend over the area of the laminated pane beyond the area of the reflective layer. Looking in the direction from the inner pane to the outer pane or from the outer pane to the inner pane means a viewing direction arranged perpendicular to the main area of the laminated pane. Within the meaning of the invention, the “complete coverage of an element A with an element B” means that the orthonormal projection of element A to the plane of element B is arranged completely within element B.

The HUD (head-up display) region of the laminated pane means a region of the laminated pane which is provided to be irradiated with a projector in a projection arrangement, so that a head-up display image can be displayed in the HUD region. The HUD region is therefore arranged in a region of the laminated pane which is transparent with a light transmittance (according to ISO 9050:2003) of preferably at least 50%, particularly preferably at least 70%. If the laminated pane is, for example, a windshield in a car, the HUD region is a region through which an observer (for example, the driver) can look at the road. It is understood that, according to the invention, the HUD region does not overlap with the masking layer when viewed through the laminated pane.

The outer pane has an outer surface facing away from the thermoplastic intermediate layer, which is also simultaneously the outer area of the laminated pane. The outer pane also has an interior-side surface facing the thermoplastic intermediate layer. The inner pane has an interior-side surface facing away from the thermoplastic intermediate layer. The interior-side surface of the inner pane is at the same time the inner surface of the laminated pane. The inner pane also has an outer surface facing the thermoplastic intermediate layer. The laminated pane is provided for separating an external environment from an interior, preferably a vehicle interior. The outer surface of the outer pane is provided here to face the external environment and the interior-side surface of the inner pane is provided to face the interior.

The laminated pane has a peripheral edge, which particularly preferably comprises an upper edge and a lower edge and two side edges running between them with a left and a right side edge. The edge which is provided to point upward in the installed position is referred to as the upper edge. The edge which is provided to point downwards in the installed position is referred to as the lower edge. The upper edge is often also referred to as the roof edge and the lower edge as the motor edge. The laminated pane can have any suitable geometric shape and/or curvature. The information “left” and “right” refer to the side indication or directional indication for an observer looking at the installed laminated pane according to the invention from an interior.

The masking layer may be an opaque enamel or may be an opaque thermoplastic film. The masking layer can also be a thermoplastic film that is opaque in regions and thus a component of the thermoplastic intermediate layer. The masking layer is in particular a dark, preferably black, enamel, which is applied to the outer pane. The masking layer is preferably applied to the interior-side surface of the outer pane. The masking layer is preferably a peripheral (frame-shaped) layer which extends along the peripheral edge of the laminated pane and can be widened in the region of the reflective layer. The masking layer serves primarily as UV protection for the structural adhesive of the laminated pane (for example, for gluing into a vehicle). The masking layer preferably has a transmittance (according to ISO 9050:2003) for visible light of less than 15%, preferably less than 10%, particularly preferably less than 1%. The masking layer can also be designed to be semi-transparent, at least in sections-for example, as a dot matrix, stripe matrix, or checkered matrix. Alternatively, the masking layer can also have a gradient-for example, from an opaque coverage to a semi-transparent coverage. “Width” within the meaning of the invention means the extent perpendicular to the extension direction.

The laminated pane can also have several, preferably two, masking layers, wherein preferably a first masking layer is applied to the interior-side surface of the outer pane and a second masking layer is applied to the interior-side surface of the inner pane. If two or more masking layers are part of the laminated pane, the “masking layer” according to the invention preferably only means one of the multiple masking layers.

In a particularly preferred embodiment of the invention, the masking layer is arranged in a frame-like manner in the peripheral edge region of the laminated pane and widens in a section of the peripheral edge region adjacent to the lower edge of the laminated pane. The masking layer preferably has a width of 10 cm or more, particularly preferably 20 cm or more, in particular 30 cm or more in the widened region. This embodiment is particularly suitable for use in vehicles in which the projection arrangement can be used as an alternative to displays installed in the dashboard. Alternatively, the masking layer can be applied in a lower edge region of the laminated pane adjacent to the lower edge and/or in an upper edge region of the laminated pane adjacent to the upper edge.

Preferably, the reflective layer is applied on the interior-side surface of the outer pane or on the outer surface of the inner pane. If the masking layer is applied to the interior-side surface of the outer pane, the reflective layer is preferably applied to the masking layer or to the outer surface of the inner pane.

The reflective layer can also be designed as a reflective film and be arranged within the thermoplastic intermediate layer. Within the meaning of the invention, “within the thermoplastic intermediate layer” means that the reflective layer is completely surrounded by the thermoplastic layer. The reflective layer can, for example, be arranged between two thermoplastic films before the lamination process, wherein the thermoplastic films fuse in the lamination process to form the thermoplastic intermediate layer. Alternatively, the reflective layer can be pressed into the thermoplastic intermediate layer by means of heat (preferably at 20 °C to 150 °C) and pressure. Within the thermoplastic intermediate layer, the reflective layer is particularly advantageously protected from external damage or corrosion. Alternatively, the reflective layer can also be applied as a reflective film to the inner pane, the masking layer or the outer pane by means of an adherent layer.

The adherent layer, which can also be called an adhesive layer, preferably has a light transmittance (according to ISO 9050:2003) of at least 50%, particularly preferably at least 70%, particularly when it is arranged between the reflective layer and the inner pane. The adherent layer is preferably based on polyurethane, polyacrylate compounds (for example, polyacrylate or polymethyl acrylate), PVB, EVA or silicone, particularly preferably based on polyurethane, polyacrylate compounds (for example, polyacrylate or polymethyl acrylate) or silicone. Alternatively, the adherent layer is based on mixtures of these materials. These materials allow a uniform application of the further pane to the inner or outer pane. Thus, largely local differences in thickness of the adherent layer between the further pane and the inner pane or outer pane can be avoided, which otherwise could impair the aesthetics of the laminated pane.

The reflective layer preferably reflects at least 40%, particularly preferably at least 70%, of visible light. Within the meaning of the invention, “reflected” means that the reflective layer reflects visible light impinging on it. Within the meaning of the invention, reflection in a specific percentage range means an average reflectance at a defined angle of incidence of 65°to the interior-side surface normal. The reflective layer is provided to reflect an image projected onto the reflective layer by a projector. The reflective layer can be transparent, but is preferably opaque.

The reflective layer is suitably designed to reflect visible light in a wavelength range from 380 nm to 780 nm. The reflective layer preferably reflects p-polarized and s-polarized light in equal proportions, but they can also reflect p-polarized light and s-polarized light to different degrees. The reflective layer preferably has a high and uniform reflectance (via different irradiation angles) to p-polarized and/or s-polarized radiation, so that a strong and color-neutral image presentation is ensured. When reflecting p-polarized light, fewer ghost images occur and thus an improved visual quality of the reflected light (for example, virtual image) is achieved. By admixing s-polarized light, the reflectance can be increased.

The reflectance is measured with an angle of incidence of 65° to the interior-side surface normal (surface normal on the interior-side surface of the inner pane), which corresponds approximately to the irradiation by conventional HUD projectors. The spectral range of 380 nm to 680 nm was used to characterize the reflection properties because the visual impression of an observer is primarily influenced by this spectral range. In addition, it covers the wavelengths relevant for the HUD representation (RGB: 473 nm, 550 nm, 630 nm).

The reflectance describes the portion of the total emitted radiation that is reflected. It is indicated in % (based upon 100%-emitted radiation) or as a unitless number from 0 to 1 (normalized to the emitted radiation). It forms the reflection spectrum when plotted as a function of the wavelength. In the context of the present invention, the statements regarding reflectance (or percentages for reflection) relative to p-polarized, unpolarized or s-polarized radiation refer to the reflectance measured with an angle of incidence of 65° to the interior-side surface normal. The information on the reflectance or the reflection spectrum relates to a reflection measurement with a light source which radiates uniformly in the observed spectral range with a standardized radiation intensity of 100%.

The reflective layer preferably extends at most over 50%, particularly preferably at most over 40%, in particular at most over 20%, of the area of the laminated pane. Particularly preferably, the reflective layer is arranged in an upper edge region of the laminated pane adjacent to the upper edge and/or in a lower edge region of the laminated pane adjacent to the lower edge of the laminated pane, wherein preferably a coating-free edge region is located between the reflective layer and the upper edge and/or lower edge. Alternatively, the reflective layer can also be arranged in addition or exclusively in a lateral edge region adjacent to one or both side edges of the laminated pane, wherein in this case too a coating-free edge region is preferably located between the reflective layer and the side edge (left and/or right side edge). The coating-free edge region preferably has a width of less than 20 cm, particularly preferably less than 10 cm, in particular less than 1 cm. The reflective layer preferably extends in a strip shape from the one (left) side edge to the other (right) side edge and is in particular adjacent to the lower edge of the laminated pane. The reflective layer preferably has a width of at least 10 cm, particularly preferably at least 20 cm, in particular at least 30 cm. The arrangement of the reflective layer in an edge region adjacent to the lower edge, left side edge, right side edge and/or upper edge is expedient in particular when the laminated pane is designed in the form of a vehicle pane, in particular a windshield, since the region of the laminated pane provided to be looked through is thus free of the reflective layer.

The reflective layer preferably comprises at least one metal selected from a group consisting of aluminum, magnesium, tin, indium, titanium, tantalum, niobium, nickel, copper, chromium, cobalt, iron, manganese, zirconium, cerium, scandium, yttrium, silver, gold, platinum and palladium, ruthenium or mixtures thereof. Alternatively or additionally, the reflective layer comprises oxides, carbides, silicon compounds, and/or nitrides selected from a group consisting of boron-doped silicon, silicon-zirconium mixed nitride, silicon nitride, titanium oxide, silicon oxide, titanium carbide, zirconium carbide, silicon zirconium aluminum, or mixtures thereof. Aluminum, titanium, nickel-chromium and/or nickel are preferably applied to the inner pane or the thin pane, since they can have a high reflection for p-polarized or s-polarized light. They are thus particularly suitable as a component of a projection arrangement. The reflective layer preferably has a thickness of 10 nm (nanometers) to 100 μm (micrometers), particularly preferably 50 nm to 50 μm, in particular 100 nm to 5 μm.

In a particularly preferred embodiment of the invention, the reflective layer is a coating containing a thin-film stack, i.e., a layer sequence of thin individual layers. This thin-film stack contains one or more electrically conductive layers based on nickel, nickel-chromium, titanium, and/or aluminum. The electrically conductive layer based on nickel, nickel-chromium, titanium, and/or aluminum gives the reflective layer basic reflective properties and also an IR-reflecting effect and an electrical conductivity. The electrically conductive layer is based on nickel, nickel-chromium, titanium, and/or aluminum. The conductive layer preferably contains at least 90 wt % nickel, titanium and/or aluminum, particularly preferably at least 99 wt % aluminum, and very particularly preferably at least 99.9 wt % nickel, titanium, and/or aluminum. The layer based on aluminum, nickel-chromium, nickel and/or titanium can have doping, for example, palladium, gold, copper, or silver. Materials based on aluminum, nickel, nickel-chromium, and/or titanium are particularly suitable for reflecting light, and particularly preferably p-polarized light. The use of nickel, nickel-chromium, titanium, and/or aluminum in reflective layers has proven to be particularly advantageous in the reflection of light. Aluminum, nickel, nickel-chromium, and/or titanium are significantly cheaper compared to many other metals such as gold or silver. In addition, these metals have a high chemical and thermomechanical resistance. The individual layers of the thin-film stack preferably have a thickness of 10 nm to 1 μm. The thin-film stack preferably has 2 to 20 individual layers and in particular 5 to 10 individual layers.

In a very particularly preferred embodiment of the invention, the reflective layer is a reflective film which is metal-free and reflects visible light, preferably predominantly p-polarized light. The reflective layer is then preferably a film which functions on the basis of synergistically interacting prisms and reflective polarizers. The reflective layer preferably has a carrier film based on polyvinyl chloride or polyethylene terephthalate. Synergistically interacting prisms and reflective polarizers are applied to this carrier film. Such films for the use of reflective layers are commercially available-for example, from the 3M company. In this way, complex metal deposition can be avoided. The reflective layer is preferably arranged as a reflective film within the thermoplastic intermediate layer.

In a further particularly preferred embodiment of the invention, the reflective layer contains
a dielectric layer stack containing TiO₂ layers and SiO₂ layers,
a dielectric layer stack containing SiZrN layers and SiO₂ layers,
a layer stack containing Si:B layers or SiZrAl layers,
a layer stack containing Si layers and SiO₂ layers,
a layer stack containing Si layers and Si₃N₄ layers, or
a carbide layer stack containing TiC layers and/or ZrC layers or consists of one or more of these layer stacks. The described layer stacks have suitable reflection properties in order to achieve a homogeneous image as part of a projection arrangement. Preferably, the described layer stacks are applied to a polymeric film (for example, based on polyethylene terephthalate (PET)).

The above-mentioned desired reflection characteristics of the reflective layer are achieved in particular by the choice of materials and thicknesses and the structure of the individual layers or layer sequences. The reflective layer can thus be suitably adjusted.

In a particularly preferred embodiment of the invention, the laminated pane also has a preferably transparent heatable functional layer. The heatable functional layer is preferably applied to the outer pane or the inner pane, in particular on the outer surface of the inner pane or the interior-side surface of the outer pane.

The heatable functional layer preferably extends over more than 50%, preferably more than 70%, particularly preferably more than 90%, of the area of the laminated pane. The heatable functional layer preferably extends at least over the entire region which is provided for looking through the laminated pane. This means the region which can be looked through and which is transparent in the finished laminated pane and optionally in the installed state (for example, installation of the laminated pane in a vehicle). In particular, the heatable functional layer extends over the entire area of the laminated pane minus a peripheral frame-shaped edge region (adjacent to the peripheral edge of the laminated pane). The uncoated peripheral frame-shaped edge region serves to better separate the functional layer from the external environment. The heatable functional layer is thereby better protected from corrosion or mechanical damage. The coating-free edge region preferably has a width of less than 20 cm, particularly preferably less than 10 cm, in particular less than 1 cm.

The heatable functional layer preferably has a light transmittance (according to ISO 9050:2003) for light in the visible spectral range of at least 50%, preferably at least 60%, and particularly preferably at least 70%. Furthermore, the heatable functional layer has a light transmittance (according to ISO 9050:2003) for light in the visible spectral range of 90% or less, preferably 80% or less, particularly preferably exactly 70%. Within the meaning of the invention, “opaque” means a light transmission (according to ISO 9050:2003) of less than 30%, preferably less than 20%, particularly preferably less than 5%, and in particular less than 0.1%. Within the meaning of the invention, “transparent” means a light transmission (according to ISO 9050:2003) of at least 50%, preferably at least 60%, and particularly preferably at least 70%.

The heatable functional layer is preferably designed to be suitable for absorbing and/or reflecting infrared light. This achieves the technical advantage that an entry of infrared light is reduced, whereby the thermal insulation effect of the laminated pane is improved.

The heatable functional layer typically contains one or more, e.g., two, three, or four, functional layers. The functional layers preferably contain at least one metal-for example, silver, gold, copper, nickel, and/or chromium, or a metal alloy. The functional layers particularly preferably contain at least 90 wt % of the metal, and in particular at least 99.9 wt % of the metal. The functional layers can consist of the metal or the metal alloy.

In a further advantageous embodiment of the laminated pane, the heatable functional layer comprises at least one silver layer and preferably several silver layers. Such silver layers have particularly advantageous electrical conductivity with simultaneously high transmission in the visible spectral range. The thickness of a silver layer is preferably from 5 nm to 50 nm, particularly preferably from 8 nm to 25 nm. In this thickness region of the silver layer, an advantageously high transmission in the visible spectral range and a particularly advantageous electrical conductivity are achieved. Preferably, at least one dielectric layer is arranged in each case between two adjacent silver layers of the coating. Preferably, a further dielectric layer is arranged below the first and/or above the last silver layer. A dielectric layer contains at least one individual layer made of a dielectric material-for example, containing a nitride such as silicon nitride or an oxide such as aluminum oxide. Dielectric layers can, however, also comprise multiple individual layers, e.g., individual layers of a dielectric material, smoothing layers, matching layers, blocker layers, and/or anti-reflective layers. The thickness of a dielectric layer is, for example, from 10 nm to 200 nm. This achieves, for example, the technical advantage that the infrared light can be effectively blocked. The blocking of infrared light is achieved particularly well when the heatable functional layer comprises at least two silver layers, particularly preferably three silver layers, and in particular exactly three silver layers. The heatable functional layer can alternatively also contain indium tin oxide (ITO), fluorine-doped tin oxide (SnO₂:F), or aluminum-doped zinc oxide (ZnO:Al) or consist thereof.

The geometric layer thickness of the heatable functional layer is preferably at most 200 nm, particularly preferably at most 100 nm, very particularly preferably at most 15 nm. As a result, an advantageous reflectivity in the IR range can be achieved without reducing the transmission too much. The geometric layer thickness of the silver layer is preferably at least 6 nm, particularly preferably at least 8 nm. Thinner silver layers can lead to a de-wetting of the layer structure. Particularly preferably, the geometric layer thickness of the silver layer is from 10 nm to 14 nm, in particular from 11 nm to 13 nm.

If thin layers are mentioned, that is to say layers with a thickness of below 1000 nm, the following applies: if something is formed “on the basis” of a material, it consists predominantly of this material, in particular substantially from this material in addition to any impurities or doping. Unless otherwise indicated, the specification of layer thicknesses or thicknesses refers to the geometric thickness of a layer.

In a particularly preferred embodiment of the invention, the heatable functional layer is electrically contacted by means of at least two busbars, so that when a DC voltage is applied, taking into account the electrical resistance between the busbars, an electrical heating current flows through the heatable functional layer. The busbars are preferably arranged in opposite edge regions of the heatable functional layer.

It is also possible for more than two busbars to be electrically contacted with the heatable functional layer. Particularly preferably, three busbars are electrically contacted with the heatable functional layer, wherein the busbars are arranged flat on the heatable functional layer so as to be spaced apart from one another. The busbars are arranged in such a way that a heating region forms between each two busbars, wherein the heatable functional layer has a total of two heating regions. A heating region can extend, for example, over the region of the laminated pane provided to be looked through, wherein the other heating region is arranged in the region of the reflective layer. In this way, the see-through region and the region of the reflective layer can be heated independently of one another. In addition, less energy is consumed since the electrical resistance increases as the distance between the busbars increases.

In principle, the reflective layer and optionally the heatable functional layer can be from physical or chemical vapor deposition, i.e., a PVD or CVD coating (PVD: physical vapor deposition, CVD: chemical vapor deposition), or can be applied, for example, by means of the sol-gel process. Such coatings can be generated with particularly high visual quality and with particularly low thickness. If the reflective layer and the optionally present heatable functional layer are a layer stack, the individual layers of the layer stack are applied consecutively, i.e., one after another. The application of layers by means of the sol-gel process is known to the person skilled in the art and can be taken, for example, from WO2021209201A1.

A PVD coating can be a coating applied (sputtered) by cathode sputtering, in particular a coating applied by magnetic field-assisted cathode sputtering (magnetron sputtering). Preferably, the reflective layer and the optionally present heatable functional layer are applied by magnetron sputtering. By means of magnetron sputtering, a homogeneous layer a few nanometers thick can be efficiently created.

If the reflective layer and the optionally present heatable functional layer are applied by means of chemical vapor deposition, this is preferably done by means of plasma-enhanced chemical vapor deposition (PECVD); in particular, this production takes place at atmospheric pressure (APCVD). The advantage of plasma-enhanced chemical vapor deposition is the speed of application with simultaneously high homogeneity of the layers compared to many other methods. In particular silicon oxide can be applied homogeneously and efficiently to a substrate by means of this production.

The reflective layer is preferably applied by physical vapor deposition (PVD) onto a film or onto the outer surface of the inner pane, particularly preferably by cathode sputtering, very particularly preferably by magnetic field-assisted cathode sputtering (“magnetron sputtering”). The reflective layer is preferably applied before the lamination.

The outer pane and the inner pane are preferably made of transparent glass, in particular of soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the outer pane and the inner pane can vary widely. Preferably, panes having a thickness in the range from 0.8 mm to 5 mm, preferably from 1.4 mm to 2.5 mm, are used, for example those with the standard thicknesses of 1.6 mm or 2.1 mm. Independently of each other the outer pane and the inner panes can be not prestressed, partially prestressed or prestressed. If at least one of the panes should be prestressed, this can be thermal or chemical prestressing.

The outer pane, the inner pane, and the laminated pane can have any three-dimensional shape. Preferably, the inner pane and the outer pane do not have any shadow zones, so that they can be coated efficiently by cathode sputtering. The inner pane and the outer pane and thus also the laminated pane are preferably flat or slightly or strongly curved in one direction or in several spatial directions.

The at least partially wedge-shaped thermoplastic intermediate layer is preferably formed as at least one thermoplastic composite film and is based on ethylene vinyl acetate (EVA), polyvinyl butyral (PVB), or polyurethane (PU) or mixtures or copolymers or derivatives thereof, particularly preferably based on polyvinyl butyral (PVB) and, in addition, additives known to the person skilled in the art, for example, plasticizers. The thermoplastic film preferably contains at least one plasticizer.

The at least partially thermoplastic intermediate layer can be formed by a single film that is wedge-shaped at least in regions or also by more than one film, wherein at least one of the films is wedge-shaped at least in regions. The thermoplastic intermediate layer can be formed by one or more thermoplastic films arranged one above the other, wherein the thickness of the thermoplastic intermediate layer after the lamination of the layer stack is preferably from 0.25 mm to 1 mm, typically 0.38 mm or 0.76 mm. The thermoplastic intermediate layer can also be formed from a film which is dyed in regions and thus opaque. The masking layer can also be a component of the thermoplastic intermediate layer. The intermediate layer can also be formed from more than one film and the at least two films can extend over different regions of the area of the laminated pane. In the case of a wedge-shaped intermediate layer, the thickness is determined at the thinnest point, typically at the lower edge of the laminated pane.

The thermoplastic intermediate layer can also be a functional thermoplastic film, in particular a film with acoustically damping properties, a film reflecting infrared radiation, a film absorbing infrared radiation, and/or a film absorbing UV radiation. For example, the thermoplastic intermediate layer can also be a bandpass filter film.

If something is formed “based on” a polymeric material, it consists predominantly, that is to say at least 50%, preferably at least 60%, and in particular at least 70%, of this material. It can thus also contain further materials such as, for example, stabilizers or plasticizers.

Due to the at least partially wedge-shaped thermoplastic intermediate layer, the laminated pane is designed in such a way that ghost images can be largely avoided when an image is projected onto the reflective layer or the HUD region. By means of the wedge film, the HUD images, which arise due to the reflections on the outer surface of the inner pane and the outer pane, can be superimposed or approximated to one another, as a result of which the layer ghost image is avoided or at least reduced. The laminated pane preferably has an anti-reflective coating, which is applied to the interior-side surface of the inner pane. The anti-reflective coating suppresses, so to speak, the reflection on the interior-side surface, so that the projection of an image is only significantly reflected on the outer surface. The anti-reflective coating preferably extends at least over the HUD region of the laminated pane, particularly preferably over at least 50% of the area of the laminated pane, and in particular over the entire area of the laminated pane.

Within the meaning of the invention, “wedge-shaped or partially wedge-shaped thermoplastic intermediate layer” means that the thermoplastic layer has, in a cross-sectional view, the shape of a wedge in a region or completely. The thermoplastic layer does not have a constant layer thickness there, but a variable layer thickness with a thicker first end and a thinner second end. The angle between the two surfaces in the wedge-shaped region of the intermediate layer is referred to as a wedge angle. If the wedge angle is not constant, the tangents to the surfaces are to be used for its measurement at one point.

The intermediate layer is wedge-shaped or wedge-like at least in the HUD region. The wedge angle can have a constant vertical curve, which leads to a linear change in thickness of the intermediate layer, wherein the thickness is typically greater from bottom to top. The direction indication “from bottom to top” denotes the direction from the lower edge to the upper edge, i.e., the vertical curve. However, more complex thickness profiles can also exist in which the wedge angle is variable from bottom to top (i.e., the vertical curve is location-dependent), linear, or non-linear.

In addition to a wedge film in the intermediate layer, a wedge-like outer pane can in principle also be used in order to angle the reflection surfaces in relation to one another.

The wedge angle is suitably selected in order to superimpose the projection images, which are caused by the reflections on the outer surface of the inner pane, on the one hand, and on the outer surface of the outer pane, on the other hand, or at least reduce their distance from one another. In the case of parallel reflection surfaces, the image (generated by reflection on the outer surface of the outer pane) and the ghost image (generated by reflection of the outer surface of the inner pane) would appear offset to one another, which is disruptive for the observer. Due to the wedge angle, the ghost image is substantially spatially superimposed with the image, so that the observer perceives only a single image or the distance between the image and the ghost image is at least reduced. Typical wedge angles are in the range from 0.3 mrad to 0.7 mrad, in particular from 0.4 mrad to 0.5 mrad. Wedge films with smaller wedge angles can be produced more easily and cost-effectively. If the wedge angle is not constant, i.e., variable, over the wedge-shaped region of the thermoplastic intermediate layer, it can have different wedge angles depending on the location, but which are all within the indicated range. The indicated upper and lower values are thus to be understood as limit values. In other words: the variable wedge angle is different depending on the location, wherein, however, it is not above or below the indicated range at any point.

The thermoplastic intermediate layer is wedge-shaped at least in the HUD region, as a result of which visible light of a projector can be reflected without or largely without ghost images.

The laminated pane can be a component of a projection arrangement, wherein the HUD region of the laminated pane can be irradiated with a projector and the reflective layer can be irradiated with a further projector. The projector and the further projector preferably project a virtual image onto the reflective layer and the HUD region, respectively. As a result of the different reflection properties, a homogeneous image can be achieved both in the HUD region on the outer surface of the outer pane and outside the HUD region on the reflective layer. This is a great advantage of the invention. If the HUD region is irradiated by means of a projector, preferably up to 30%, particularly preferably up to 20%, in particular up to 15% of the visible light (radiation) of the projector impinging on the HUD region is reflected.

A further aspect of the invention relates to a projection arrangement comprising a laminated pane according to the invention, a projector, which projects an image in the form of visible radiation (visible light), preferably over the inner pane, onto the HUD region of the laminated pane, and a further projector, which projects an image in the form of visible radiation (visible light), preferably over the inner pane, onto the reflective layer. In other words: the respective projector irradiates the HUD region or the reflective layer with visible light, wherein the reflective layer and the outer pane and inner pane at least partially reflect the visible light. The projector and the further projector are preferably facing the interior-side surface of the inner pane. If the laminated pane is in an installed state (for example, as a windshield in a vehicle), the projector and the further projector irradiate the reflective layer or the HUD region from an interior (vehicle interior).

The radiation from the projector and the further projector, independently of one another, preferably has a p-polarized portion of >0%. In principle, the p-polarized portion can also be 100%, i.e., the projectors emit purely p-polarized radiation. However, it is advantageous for the total intensity of the HUD image if the radiation from the projector has both s-polarized and p-polarized proportions. In this case, the p-polarized radiation portions are efficiently reflected by the reflective layer and the s-polarized radiation portions are reflected by the pane surfaces. The ratio of p-polarized radiation portions to s-polarized radiation portions can be freely selected according to the requirements in individual cases. The proportion of p-polarized radiation in the total radiation from the projector and/or the further projector is, for example, from 10% to 100%, preferably from 10% to 90%. In a particularly advantageous embodiment, the proportion of p-polarized radiation from the projector and/or from the further projector is at least 50%, that is to say from 50% to 90%, preferably from 60% to 80%, as a result of which it is ensured in particular that a driver with polarization-selective sunglasses can perceive a strong image. In a particularly advantageous embodiment, the radiation from the further projector is substantially purely p-polarized—the p-polarized radiation portion is therefore 100% or deviates only insignificantly therefrom. As a result, double images are largely prevented.

The indication of the polarization direction refers to the plane of incidence of the radiation on the laminated pane. P-polarized radiation refers to a radiation, the electric field of which oscillates in the plane of incidence. S-polarized radiation refers to a radiation, the electric field of which oscillates perpendicular to the plane of incidence. The plane of incidence is spanned by the incident vector and the surface normal of the laminated pane in the geometric center of the irradiated region.

If the projection arrangement is a component of a vehicle, the projector and the further projector are preferably arranged in the dashboard of the vehicle. The image projected by the further projector onto the reflective layer and the image projected by the projector onto the HUD region of the laminated pane are thereby reflected into the vehicle interior, for example, into the field of vision of an occupant. Due to the reflective layer, which is arranged in front of the masking layer, the image projected onto the reflective layer can be perceived visually with a high contrast. As a result, projectors requiring less energy can be used. In comparison to projectors for classic head-up displays, the energy required by the projector can be reduced by up to 80%.

The projector and/or the further projector are preferably a liquid-crystal display (LCD), thin-film transistor (TFT) display, light-emitting diode (LED) display, organic light-emitting diode (OLED) display, electroluminescent display (ELD), or micro-LED display.

As is usual in the case of HUDs and projection arrangements based on similar technology, the projector and the further projector irradiate the reflective layer or the HUD region of the laminated pane, in particular with a p-polarized radiation in the wavelength range from 380 nm to 780 nm. This means that a projection area of the reflective layer or the laminated pane is irradiated with the further projector or projector. The p-polarized and/or s-polarized radiation is reflected in the region of the projection area in the direction of an observer, as a result of which a virtual image is generated which the observer perceives, when viewed from his perspective, behind the laminated pane (in the case of an HUD). The beam direction of the projector and/or the further projector can typically be varied by mirrors, in particular vertically, in order to adapt the projection to the body size of the observer. The area in which the observer's eyes must be located at a given mirror position is referred to as the eye box window. This eye box window can be displaced vertically by adjusting the mirrors, wherein the entire area accessible as a result (i.e., the superimposition of all possible eye-box windows) is referred to as the eye box. An observer located within the eye box can perceive the virtual image. This means, of course, that the observer's eyes must be located within the eye box, not, for instance, the entire body.

The technical terms used here from the field of HUDs are generally known to the person skilled in the art. For a detailed depiction, reference is made to the dissertation “Simulation-based measurement technique for testing head-up displays” by Alexander Neumann at the Institute for Informatics of the Technical University of Munich (Munich: university library of TU Munich, 2012), in particular to Chapter 2 “The Head-Up Display.”

The above embodiments and preferred embodiments in connection with the laminated pane or the projection arrangement apply equally to the method. The following embodiments and preferred embodiments in connection with the method according to the invention apply equally to the laminated pane and projection arrangement.

A further aspect of the invention relates to a method for producing the laminated pane according to the invention. The method steps comprise, preferably in the indicated sequence, the following method steps:
(A) A layer stack made of the outer pane, the thermoplastic intermediate layer (4), the masking layer, and the inner pane is provided,
(B) the reflective layer is arranged between the outer pane and the inner pane, preferably within the thermoplastic intermediate layer, and
(C) the layer stack is laminated to form the laminated pane.

Lamination of the layer stack takes place under the action of heat, vacuum, and/or pressure, wherein the individual layers are bonded (laminated) by at least one thermoplastic film. Methods known per se for producing a laminated pane can be used. For example, so-called autoclave processes can be carried out at an elevated pressure of about 10 bar to 15 bar and temperatures of 130 °C to 145 °C over about 2 hours. Vacuum bag or vacuum ring methods known per se operate, for example, at approximately 200 mbar and 130 °C to 145 °C. The layer stack may also be pressed in a calender between at least one pair of rollers to form a laminated pane. Systems of this type for the production of laminated panes are known and usually have at least one heating tunnel upstream of a pressing unit. The temperature during pressing is, for example, from 40 °C to 150 °C. Combinations of calender and autoclave methods have proven particularly successful in practice. Vacuum laminators can be used as an alternative. They consist of one or more heatable and evacuable chambers, in which the outer pane and the inner pane can be laminated within, for example, approximately 60 minutes at reduced pressures of 0.01 mbar to 800 mbar and temperatures of 80 °C to 170 °C

The laminated pane according to the invention can be, for example, the roof panel, windshield, side window, or rear window of a vehicle or another vehicle glass, for example a separating pane in a vehicle, preferably in a rail vehicle, a car, or a bus. Alternatively, the laminated pane can be an architectural glass, for example, in an outer facade of a building or a separating pane in the interior of a building, or a built-in part in furniture or devices.

The invention is explained in more detail below with reference to exemplary embodiments, wherein reference is made to the accompanying figures. The figures are schematic representations and are not true to scale. The figures do not limit the invention in any way. In the figures:

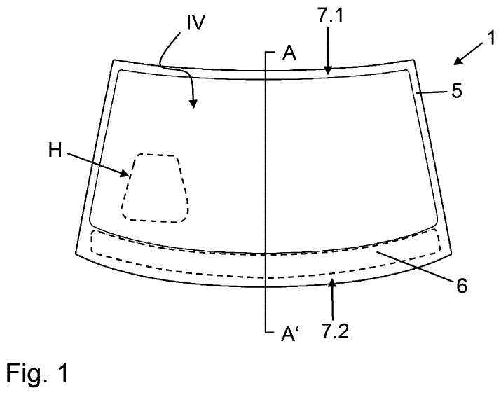

FIG. 1 shows an embodiment of the laminated pane according to the invention in a plan view,

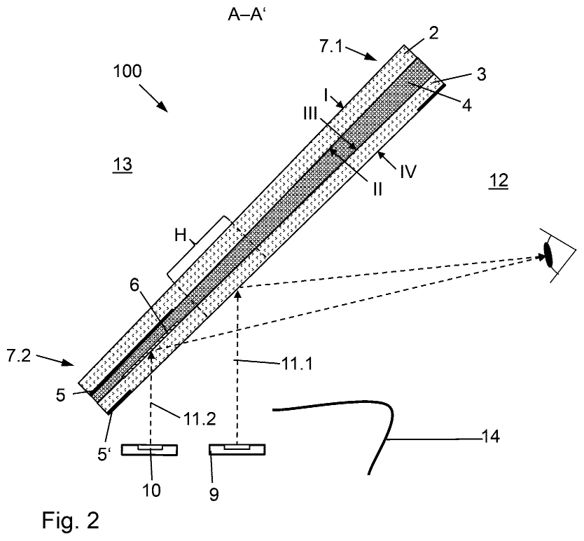

FIG. 2 shows a cross-sectional view of a projection arrangement with the laminated pane from FIG. 1,

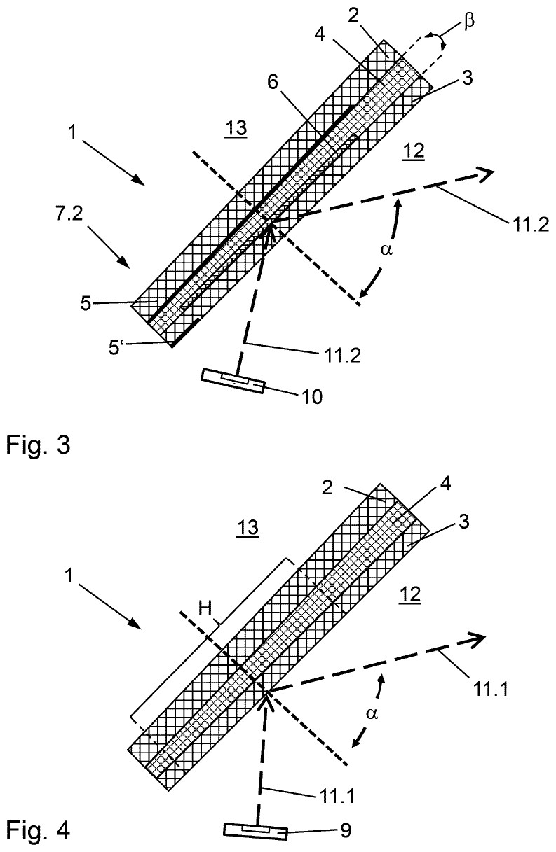

FIG. 3 shows an enlarged lower edge region of the projection arrangement from FIG. 2 in a cross-sectional view, and

FIG. 4 shows an enlarged HUD region of the projection arrangement from FIG. 2 in a cross-sectional view, and

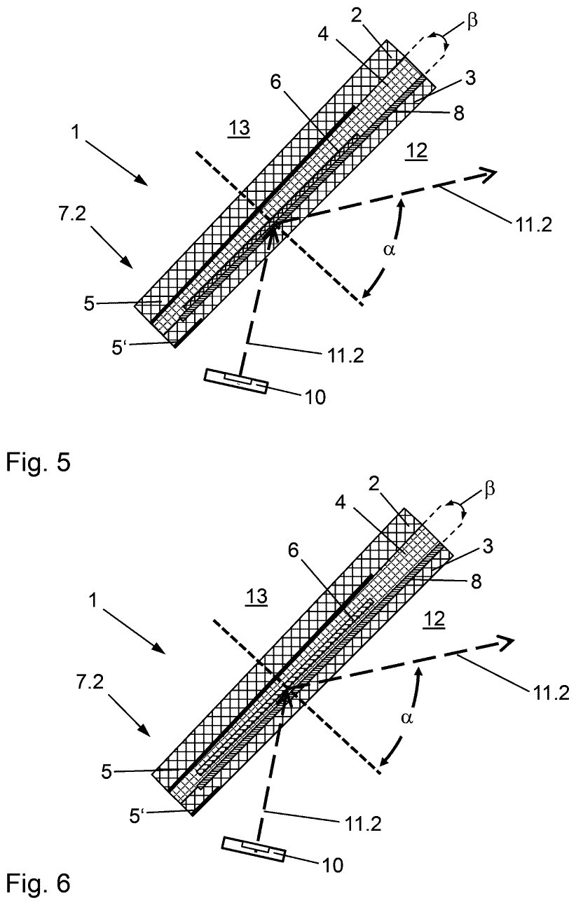

FIGS. 5-6 show further embodiments of the laminated pane according to the invention in a projection arrangement in a cross-sectional view.

FIGS. 1 to 4 show different aspects of an embodiment of the laminated pane 1 according to the invention. FIG. 1 shows the laminated pane 1 according to the invention in the form of a windshield for a vehicle. The laminated pane 1 is shown in a plan view, wherein an interior-side surface IV of the laminated pane 1 is viewed. FIG. 2 shows the laminated pane 1 as a component of a projection arrangement 100 according to the invention in a cross-sectional view, wherein the projection arrangement 100 is installed in a vehicle. The cross-sectional view of FIG. 2 corresponds to intersection line A-A′ of the laminated pane 1, as indicated in FIG. 1. FIG. 3 shows an enlarged detail of projection arrangement 100 from FIG. 2, wherein the enlarged detail shows a lower edge region 7.2 adjacent to the lower edge of laminated pane 1. FIG. 4 shows an enlarged detail of the projection arrangement 100 from FIG. 2, wherein a see-through region of the laminated pane 1 with an HUD region H is shown.

The laminated pane 1 has an upper edge and a lower edge and two side edges connecting the upper edge and the lower edge (all together results in a peripheral edge of the laminated pane 1). The lower edge (also called the motor edge) of the laminated pane 1 means the edge that faces the floor in the installed position. The upper edge (also called the roof edge) of the laminated pane 1 means the edge that faces the vehicle roof in the installed position in a vehicle.

The laminated pane 1 comprises an outer pane 2, an inner pane 3, and a wedge-shaped thermoplastic intermediate layer 4 arranged between the outer pane 2 and the inner pane 3. The outer pane 2 has an outer surface I facing away from the thermoplastic intermediate layer 4 and an interior-side surface II facing the thermoplastic intermediate layer 4. The inner pane 3 has an outer surface III facing the thermoplastic intermediate layer 4 and an interior-side surface IV facing away from the thermoplastic intermediate layer 4. The outer surface I of the outer pane 2 is also simultaneously the surface of the laminated pane 1 that faces the outer environment 13, and the interior-side surface IV of the inner pane 3 is also simultaneously the surface of the laminated pane 1 that faces the interior 12 of the vehicle. The laminated pane 1 has, for example, a shape and curvature that are conventional for windshields.

The outer pane 2 and the inner pane 3 each consist of glass-preferably thermally pre-stressed soda-lime glass- and are transparent to visible light. The outer pane 2 has, for example, a thickness of 2.1 mm and the inner pane 3 has, for example, a thickness of 1.5 mm. The thermoplastic intermediate layer 4 comprises a thermoplastic, preferably polyvinyl butyral (PVB), ethylene vinyl acetate (EVA), and/or polyethylene terephthalate (PET). The thermoplastic intermediate layer 4 is wedge-shaped, wherein the thickest region of the intermediate layer 4 is arranged at the upper edge of the laminated pane 1 and the thinnest end being arranged at the lower edge of the laminated pane 1. The wedge angle β of the thermoplastic intermediate layer 4 is, for example, 0.2 mrad. Within the meaning of the invention, an embodiment would also be possible in which the thermoplastic intermediate layer 4 is wedge-shaped only in the HUD region H and otherwise has a constant thickness (not shown here).

An opaque masking layer 5 is applied to the interior-side surface II of the outer pane 2. A further opaque masking layer 5′ is applied on the interior-side surface IV of the inner pane 3. The masking layer 5 and the further masking layer 5′ extend in a frame-like manner along the peripheral edge of the laminated pane 1. Compared to the upper edge region 7.1 directly adjacent to the upper edge of the laminated pane 1, the masking layer 5 is applied wider in the lower edge region 7.2 directly adjacent to the lower edge of the laminated pane 1. The masking layer 5 and the further masking layer 5′ are opaque and obstruct the view of structures arranged on the inside or the outside of the laminated pane 1—for example, an adhesive bead for gluing the laminated pane 1 into a vehicle body. The masking layer 5 and the further masking layer 5′ consist of an electrically non-conductive material traditionally used for black printing—for example, a black-colored screen printing ink which is burnt in.

The laminated pane 1 has an HUD region H, which is provided to display a head-up display image for a driver or passenger of the vehicle. The HUD region H is arranged in the see-through region of the laminated pane 1 so that an image projected onto the HUD region H can be perceived for an observer as if it would appear behind the laminated pane 1 (i.e., in the external environment 13) (HUD technology).

An opaque reflective layer 6 is applied to regions of the outer surface III of the inner pane 3. This is located overlapping with the masking layer 5 in the lower edge region 7.2 of the laminated pane 1, i.e., is arranged closer to the lower edge than to the upper edge of the laminated pane 1. In the installed position, the reflective layer 6 is arranged in the surroundings of the dashboard 14. The opaque reflective layer 6 thus extends from the left side edge to the right side edge of the laminated pane 1. The reflective layer 6 has, for example, a width of 30 cm. The reflective layer 6 is also arranged in such a way that it completely overlaps the widened section of the masking layer 5 when viewed through the laminated pane 1 as seen from the interior 13. The reflective layer 6 is therefore arranged on the vehicle interior side in front of the masking layer 5. It is conversely understood that the masking layer 5 completely covers the reflective layer 6 when viewed from the external environment 14 through the laminated pane 1. The opaque reflective layer 6 is arranged outside of a see-through region provided for being looked through and of the HUD region H of the laminated pane 1. The reflective layer 6 is, for example, a film on the basis of synergistically interacting prisms and reflective polarizers. The reflective layer 6 is applied, for example, by means of an adherent layer to the outer surface III of the inner pane 3. Alternatively, it can also be placed only on the outer surface III. The opaque reflective layer 6 is, for example, suitably designed to reflect visible light at least 30%.

A projector 9 and a further projector 10 are arranged on a dashboard 14 of the vehicle, each of which projects a virtual image in the form of visible radiation (light) 11.1, 11.2 on the opaque reflective layer 6 or the HUD region H of the laminated pane 1. The irradiation angle a with which the visible radiation 11.1, 11.2 from the projector 9 or from the further projector 10 impinges on the interior-side surface IV of the inner pane 3 is, for example, 65°. The projector 9 projects a virtual image in the form of visible radiation 11.1 onto the HUD region H of the laminated pane 1. The HUD region H irradiated by the projector 9 is indicated in FIG. 1 by a dashed trapezoidal region on the laminated pane 1. The further projector 10 projects a virtual image in the form of visible radiation 11.2 onto the opaque reflective layer 6. The region of the opaque reflective layer 6 irradiated by the further projector 10 is indicated in FIG. 1 by a dashed strip-shaped region on the laminated pane 1. The visible radiation 11.1, 11.2 of the projector 9 and of the further projector 10 is reflected on the reflective layer 6 or the outer surface I of the outer pane 2 and the outer surface III of the inner pane 3, and the reflected radiation 11.1, 11.2 is visually perceived by an observer (for example, the driver of the vehicle). Due to the wedge-shaped configuration of the thermoplastic intermediate layer 4, double images due to the double reflection on the outer pane 2 and inner pane 3 are reduced. Due to the wedge shape of the thermoplastic intermediate layer 4, the reflections on the outer surface I of the outer pane 2 and the outer surface III of the inner pane 3 are brought into alignment with one another, as a result of which only one image is discernible for the observer.

The projector 9 irradiates an HUD region H of the laminated pane 1, thereby creating an HUD image (head-up display image) for the observer. The further projector 10 irradiates the opaque reflective layer 6 outside the HUD region H, which is additionally arranged in front of a masking layer 5. Since the reflective layer 6 is opaque and is arranged in front of an opaque masking layer 5, the virtual image is visually perceptible with a higher contrast (comparison to HUD image). This makes it possible to use projectors 10 with a low light intensity, that is to say a lower energy consumption. The projector 9 and the further projector 10 are, for example, light-emitting diode displays (LED display).

Reference is now made to FIGS. 5 and 6, in which enlarged cross-sectional views of various embodiments of the laminated pane 1 are shown. The cross-sectional views of FIGS. 5 and 6 correspond to intersection line A-A′ in the lower edge region 7.2 adjacent to lower edge of the laminated pane 1, as indicated in FIG. 1 and FIG. 2. The variants shown in FIGS. 5 and 6 corresponds substantially to the variant from FIGS. 1 to 4, so that only the differences will be discussed here, and reference is otherwise made to the description relating to FIGS. 1 to 4.

Unlike the variant from FIGS. 1 to 4, a heatable functional layer 8 is additionally applied to the outer surface III of the inner pane 3 in FIG. 5. The heatable functional layer 8 extends over the entire outer surface III of the inner pane 3 with the exception of a peripheral edge region and optionally local regions, which are intended to ensure the transmission of electromagnetic radiation through the laminated pane 1 as communication, sensor or camera windows (not shown) and are therefore not provided with the heatable functional layer 8. The peripheral uncoated edge region has, for example, a width of 2 cm. It prevents the direct contact of the heatable functional layer 8 with respect to the surrounding atmosphere, so that the heatable functional layer 8 in the interior of the laminated pane 1 is protected from corrosion and damage and the vehicle body is electrically insulated from the heatable functional layer 8. The heatable functional layer 8 is, for example, a thin-layer stack comprising a silver layer having a layer thickness of 15 nm.

Unlike in FIGS. 1 to 4, the reflective layer 6 is not applied to the outer surface III of the inner pane 3 but to the heatable functional layer 8. Alternatively, it is also possible for the reflective layer 6 to be applied to the outer surface III of the inner pane 3 and for the heatable functional layer 8 to be applied thereto in the region of the reflective layer 6 (not shown here).

As described in FIG. 5, a heatable functional layer 8 is also applied to the outer surface III of the inner pane 3 in FIG. 6. In this embodiment, however, the reflective layer 6 is arranged within the thermoplastic intermediate layer 4. The reflective layer 6 is arranged, for example, before lamination of the laminated pane 1 between two thermoplastic composite films. Due to the lamination, these composite films fuse to the thermoplastic intermediate layer 4, wherein the reflective layer 6 is completely surrounded by the thermoplastic intermediate layer 4.

### REFERENCE SIGNS

1 Laminated pane
2 Outer pane
3 Inner pane
4 Thermoplastic intermediate layer
5 Masking layer
5 Further masking layer
6 Reflective layer
7.1 Upper edge region of the laminated pane 1
7.2 Lower edge region of the laminated pane 1
8 Heatable functional layer
9 Projector
10 Further projector
11.1 Visible radiation from the projector 9
11.2 Visible radiation from the further projector 10
12 Interior
13 External environment
14 Dashboard
100 Projection arrangement
H HUD region
a Irradiation angle
B Wedge angle of the thermoplastic intermediate layer 4
I Outer surface of the outer pane 2
II Interior-side surface of the outer pane 2
III Outer surface of the inner pane 3
IV Interior-side surface of the inner pane 3
A-A′ Intersection line

1. A laminated pane for a projection arrangement having a head-up display (HUD) region comprising:
an outer pane, a thermoplastic intermediate layer, and an inner pane,
a masking layer, and
a reflective layer,
wherein the reflective layer is arranged between the outer pane and the inner pane and outside the HUD region of the laminated pane, and
wherein the reflective layer is arranged closer than the masking layer to the inner pane and is arranged completely within the masking layer in a plan view of the laminated pane as seen from the inner pane, wherein the thermoplastic intermediate layer is wedge-shaped at least in the HUD region.

2. The laminated pane according to claim 1, wherein the reflective layer is applied to a surface of the inner pane facing the thermoplastic intermediate layer.

3. The laminated pane according to claim 1, wherein the reflective layer is arranged within the thermoplastic intermediate layer

4. The laminated pane according to claim 1, wherein the reflective layer has a reflectance for visible radiation of at least 40%.

5. The laminated pane according to claim 1, wherein the reflective layer contains silicon, aluminum, zirconium, nickel, chromium, boron-doped silicon, silicon-zirconium mixed nitride, silicon nitride, titanium oxide, silicon oxide, titanium carbide, zirconium carbide, silicon-zirconium-aluminum, and/or mixtures thereof.

6. The laminated pane according to claim 1, wherein the reflective layer is designed as a film on the basis of synergistically interacting prisms and reflective polarizers.

7. The laminated pane according to claim 1, wherein the masking layer is arranged in an upper or lower edge region of the laminated pane.

8. The laminated pane according to claim 1, wherein a heatable functional layer is arranged between the outer pane and the inner pane.

9. The laminated pane according to claim 8, wherein the heatable functional layer comprises at least one silver layer.

10. The laminated pane according to claim 1, wherein the thermoplastic intermediate layer is wedge-shaped over the entire area of the laminated pane.

11. The laminated pane according to claim 1, wherein the wedge angle of the thermoplastic intermediate layer is from 0.3 mrad to 0.7 mrad.

12. A projection arrangement comprising
a laminated pane according to claim 1,
a projector which projects visible radiation onto the HUD region of the laminated pane, and
a further projector which is configured to project visible radiation onto the reflective layer.

13. The projection arrangement according to claim 12, wherein the proportion of p-polarized radiation in the visible radiation from the projector and the further projector is from 50% to 90%.

14. A method for producing a laminated pane according to claim 1, comprising:
providing a layer stack made of the outer pane, the masking layer the thermoplastic intermediate layer, and the inner pane,
arranging the reflective layer between the outer pane and the inner pane, and
laminating the layer stack to form the laminated pane,

15. A method comprising providing a laminated pane according to claim 1 in a locomotion vehicle for traffic on land, in the air, or in water, or as a functional and/or decorative individual piece and or a built-in part in furniture, devices, an or buildings.

16. The laminated pane according to claim 4, wherein the reflective layer has a reflectance for visible radiation of at least 70%.

17. The laminated pane according to claim 9, wherein the heatable functional layer comprises at least two silver layers.

18. The laminated pane according to claim 17, wherein the heatable functional layer comprises at least three silver layers.

19. The laminated pane according to claim 11, wherein the wedge angle of the thermoplastic intermediate layer is from 0.4 mrad to 0.5 mrad.

20. The method according to claim 15, wherein the laminated pane is a windshield, a rear pane, a side pane and/or a glass roof of the vehicle.
